(19) United States
(12) Patent Application Publication
(10) Pub. No.: US 2021/0206028 A1
(43) Pub. Date: Jul. 8, 2021

(54) TIRE VULCANIZING MACHINE AND TIRE VULCANIZING METHOD

(71) Applicant: ROCKY-ICHIMARU CO., LTD., Chikugo-shi (JP)

(72) Inventor: Hironobu ICHIMARU, Chikugo-shi (JP)

(21) Appl. No.: 17/055,953

(22) PCT Filed: May 16, 2018
(86) PCT No.: PCT/JP2018/018934

§ 371 Date: Nov. 16, 2020

(51) Int. Cl. B29C 35/02; B29D 30/06

(52) U.S. Cl. CPC B29C 35/02; B29C 33/202; B29D 30/0601

(57) ABSTRACT

A tire-vulcanizing machine for positioning a green tire and a mold via a mold-clamping process, the tire-vulcanizing machine including two guide rods, the mold which includes an upper mold and a lower mold, a bolster, a base, a mold-elevating device, two clamping rods, and guide bushes provided on the bolster.

### TECHNICAL FIELD

The present disclosure relates to a tire-vulcanizing machine and a tire-vulcanizing method. More specifically, the present disclosure relates to a tire-vulcanizing machine, which is capable of positioning a green tire and a mold with high accuracy in a mold-clamping process and attaining device miniaturization, and is excellent in handleability, and to a tire-vulcanizing method.

### BACKGROUND ART

In the manufacture of a tire, a green tire, which has been previously molded into a shape close to a finished product, is placed in a mold, pressed, and heated. At this time, a bladder provided in the mold is expanded and brought into close contact with the inner surface of the green tire so as to perform vulcanization.

The tire-vulcanizing machine is also provided with a clamping mechanism and a mold-pressing mechanism for maintaining the clamped state of the mold against pressure generated inside the mold when the green tire is vulcanized.

Among these, in the clamping mechanism, there is a clamping position for fixing the positions of upper and lower plates on which paired molds are respectively mounted in accordance with the height of the clamped mold. That is, the upper plate or the lower plate is moved, and the upper and lower plates are fixed using the position at which the clamped mold can be fixed as the clamping position.

Because the upper and lower plates are fixed as described above, it is possible to prevent the mold from opening due to the pressure generated inside the mold during tire vulcanization, and to maintain the mold in the clamped state.

The clamping position in this clamping mechanism is defined by, for example, a clamping-groove formation position on a guide rod that guides the movement of the upper plate or the lower plate.

Among the upper plate and the lower plate, a moving plate is provided with a clamping part that is engaged with the clamping groove, and the clamping part is engaged with the clamping groove, whereby the upper and lower plates are fixed.

As the clamping mechanism, there is also a structure in which, apart from the guide rod, a rod-shaped clamping rod having a clamping groove formed at the tip end thereof is provided on one of the upper and lower plates, and a clamping part is provided on the other plate so that the upper and lower plates are fixed when the tip end of the clamping rod reaches the clamping part and is engaged and locked with the clamping part.

In the tire-vulcanizing machine, with the improvement of tire performance and the like, the demand for accuracy of, for example, concentricity between a mold and a tire during tire vulcanization, is becoming stricter. For this reason, among various structures, a tire-vulcanizing machine having a vertical-elevation-type mold that can easily guarantee accuracy of, for example, concentricity between a mold and a tire is widely used.

Under these circumstances, the tire-vulcanizing machine having a vertical-elevation-type mold, for example, the tire-vulcanizing machine described in Patent Document 1, has the following structure (see FIGS. 1A and 1B and FIG. 2).

The tire-vulcanizing machine 100 described in Patent Document 1 has a bolster 5 (an upper plate), a base 10 (a lower plate), and two guide rods 1 connecting the bolster 5 and the base 10 to each other.

In addition, two upper molds 2a are mounted on the left and right sides of the bolster 5. In addition, two lower molds 2b are mounted on the left and right sides of the base 10, and a bladder 11a on which a green tire 13 can be mounted is provided on each of the lower molds.

That is, in the tire-vulcanizing machine 100, a pair of upper and lower molds 2 (the upper mold 2a and the lower mold 2b) is disposed on each of the left and right sides of the guide rod 1.

In this tire-vulcanizing machine 100, green tires 13 are respectively fitted on the outsides of the contracted bladders 11a by a tire-loading device before the molds are fully closed, and are respectively disposed above the lower molds 2b.

The upper molds 2a are configured to be integrally movable up and down with the bolster 5 by a hydraulic cylinder 8. The upper molds 2a are guided by the guide rod 1 and descend from the state in which the molds are opened (see FIG. 1B) to a tire vulcanization position at which the molds are fully closed (a mold-clamping position (see FIG. 2)).

In the tire-vulcanizing machine 100, after the molds are fully closed, clamping grooves 1a provided in the guide rods 1 and clamping devices 4 provided on the bolster 5 are engaged with each other. Clamping devices 4 provided on the base 10 are engaged with clamping grooves 14a provided on the tip end sides of clamping rods 14.

Then, because respective clamping devices 4 are engaged and locked with the clamping grooves 1a and the clamping grooves 14a, the bolster 5 and the base 10 are fixed. By this fixing, it is possible to prevent the molds from opening due to the pressure generated inside the mold during tire vulcanization, and to maintain the clamped state of the molds.

As described above, because the upper molds 2a move up and down with respect to the lower molds 2b in the vertical direction, the molds 2 are fully closed and the green tires 13 are vulcanized.

### PRIOR ART DOCUMENT

### Patent Document

Patent Document 1: Japanese Patent No. 3254100

### DETAILED DESCRIPTION OF THE INVENTION

### Technical Problem

However, in the tire-vulcanizing machine 100 described in Patent Document 1 described above, the upper molds 2a are guided up and down only by two guide rods 1 provided at substantially the center of the bolster 5 when viewed from the front. At this time, each upper mold 2a is in a so-called cantilevered state with respect to the guide rods 1 without a structure supporting the upper mold 2a on the outside.

In this way, because the upper molds 2a are in a cantilevered state and are supported only by the guide rods 1 at substantially the approximate center therebetween, the upper molds 2a are tilted due to the clearances between the guide rods 1 and sliding bushes (not illustrated), which slide on the outer peripheral surfaces of the guide rods 1, respectively.

That is, if the weights of the upper molds 2a and the pressing forces during tire vulcanization are different between the left and right molds 2, the upper molds 2a will tilt due to the clearances between the guide rods 1 and the sliding bushes. As a result, misalignment occurs between the center positions of the molds 2 and the center positions of the green tires 13, and thus the concentricity is impaired, which greatly affects the quality of the tires after vulcanization.

In order to eliminate tilting of the upper molds 2a, it is conceivable to provide a plurality of guide rods 1 for one mold 2. However, with this structure, the tire-vulcanizing machine is enlarged, and thus the space for installing the tire-vulcanizing machine is limited.

In addition, enlargement of the tire-vulcanizing machine hinders the work of mounting and removing the tires before and after tire vulcanization, the work of replacing the molds, and the like.

The present disclosure was made in view of the above points, and an object of the present disclosure is to provide a tire-vulcanizing machine, which is capable of positioning a green tire and a mold with high accuracy in a mold-clamping step, is capable of attaining device miniaturization, and is excellent in handleability, and to provide a tire-vulcanizing method.

### Technical Solution

In order to achieve the object described above, a tire-vulcanizing machine of the present disclosure may include: a first plate on which a first mold is mounted, the first mold being provided with a bladder configured to heat and press a green tire; a second plate on which a second mold is mounted, the second mold being configured to cooperate with the first mold so as to hold the bladder therebetween; a substantially columnar guide rod mounted on the first plate and the second plate so as to guide relative movement of the first plate and the second plate; a mold-moving mechanism configured to move the first plate and the second plate relative to each other along the guide rod; a clamping mechanism including a clamping rod, which is a substantially columnar body provided on either one of the first plate and the second plate and protruding towards a remaining plate, wherein the clamping rod has a first clamping groove formed at a protruding tip end side thereof, and a first clamping part provided on the remaining plate at a position facing the tip end of the clamping rod, wherein the first clamping part is engaged with the first clamping groove so as to fix a relative position between the first plate and the second plate and to maintain the clamped state of the first mold and the second mold; and a guide mechanism configured to guide the movement of the tip end side of the clamping rod from a position at which the green tire mounted on the bladder and a surface of the second mold facing the green tire are located close to each other when the first plate and the second plate are moved relative to each other by the mold-moving mechanism to clamp the molds.

Here, with the first mold provided with the bladder configured to heat and press the green tire and the second mold configured to cooperate with the first mold to be able to hold the bladder therebetween, the bladder is sandwiched between the first mold and the second mold. Thus, it is possible to perform vulcanization by heating and pressing the green tire disposed between each mold and the bladder.

In addition, with the first plate on which the first mold is mounted, the second plate on which the second mold is mounted, the guide rod mounted on the first plate and the second plate so as to guide the relative movement of the first plate and the second plate, and the mold-moving mechanism configured to move the first plate and the second plate along the guide rod relative to each other, it is possible to clamp the first mold and the second mold by moving the first plate or the second plate along the guide rod. Further, after the tire vulcanization is completed, the first mold and the second mold can be separated from each other so as to be released from the clamped state. Here, the wording “to move the first plate and the second plate relative to each other” includes both an aspect in which the first plate is fixed and the second plate is moved and an aspect in which the second plate is fixed and the first plate is moved.

With the substantially columnar guide rod mounted on the first plate and the second plate so as to guide the relative movement of the first plate and the second plate, the mold-moving mechanism configured to move the first plate and the second plate relative to each other along the guide rod, and the clamping mechanism including a clamping rod, which is a substantially columnar body provided on either one of the first plate and the second plate and protruding towards the remaining plate, wherein the clamping rod has a first clamping groove formed at a protruding tip end side thereof, and a first clamping part provided on the remaining plate at a position facing the tip end of the clamping rod, wherein the first clamping part is engaged with the first clamping groove so as to fix the relative position between the first plate and the second plate and to maintain the clamped state of the first mold and the second mold, it is possible to maintain the molds in the clamped state by moving the first plate or the second plate along the guide rod and fixing the position of each plate using the clamping mechanism. That is, it is possible to suppress, by the clamping mechanism, the phenomenon in which the first mold and the second mold, which have been clamped, tend to open due to the pressure generated when the tire is heated and pressed. Here, the wording “to move the first plate and the second plate relative to each other” includes both an aspect in which the first plate is fixed and the second plate is moved and an aspect in which the second plate is fixed and the first plate is moved.

With the guide mechanism configured to guide the movement of the tip end side of the clamping rod from a position at which the green tire mounted on the bladder and the surface of the second mold facing the green tire are located close to each other when the first plate and the second plate are moved relative to each other by the mold-moving mechanism to clamp the molds, it is possible to prevent misalignment of the center position of the green tire and the center position of the second mold from easily occurring. That is, when the first mold and the second mold are clamped, the guide mechanism guides the movement of the tip end side of the clamping rod. Thus, the movement of the clamping rod, the first mold, or the second mold is stabilized. Along therewith, for example, even if the second mold mounted on the second plate is in a cantilevered state when viewed from the guide rod, it is possible to suppress misalignment of the center position of the second mold due to bending or the like when guiding using the guide mechanism is started.

When the guide mechanism is constituted with the guide bush, which is a substantially tubular body provided at the position of the first clamping part on the remaining plate and through which the tip end side of the clamping rod is insertable, it is possible to guide the movement of the clamping rod inside the guide bush. That is, due to the movement by the mold-moving mechanism, the tip end of the clamping rod approaches the guide bush, and the tip end of the clamping rod enters the through hole in the guide bush. Then, the movement of the clamping rod is guided by the guide mechanism until the clamping groove in the clamping rod reaches a position at which the clamping groove is engaged with the first clamping part. In other words, the tip end side of the clamping rod is guided by the length of the guide bush, and the movement of the clamping rod, the first mold, or the second mold is stabilized. The one plate referred to here is the plate on the side on which the clamping rod is provided (the first plate or the second plate), and the remaining plate is the plate that is paired with the one plate (the second plate or the first plate).

When the guide mechanism is constituted with the guide rod having a length that causes the tip end to be engaged with the first clamping part at the position at which the green tire mounted on the bladder and the surface of the second mold facing the green tire are located close to each other, engagement with the clamping part at the tip end side of the guide rod is started just before the green tire is covered with the first mold and the second mold. That is, while the first mold and the second mold are clamped from above and below with the green tire sandwiched therebetween, the tip end of the clamping rod is guided, and thus the movement of the clamping rod, the first mold, or the second mold is stabilized. That is, for example, it is possible to provide a guide mechanism through a simple modification of increasing the length of the clamping rod in a known tire-vulcanizing machine.

When the guide mechanism is constituted with a guide bush, which is a substantially tubular body provided on the remaining plate at the position of the first clamping part, and through which the tip end side of the clamping rod is insertable, the guide rod having a length that causes the tip end to be engaged with the guide bush at a position at which the green tire mounted on the bladder and the surface of the second mold facing the green tire are located close to each other, it is possible to guide the tip end side of the clamping rod based on the lengths of the guide bush and the clamping rod. As a result, the movement of the clamping rod, the first mold, and the second mold is further stabilized. In addition, it is possible to avoid a structure in which the length of the clamping rod becomes excessive, which contributes to miniaturization of the entire device and improves handleability.

When the guide rod has the second clamping groove formed at a predetermined position in the longitudinal direction and the tire-vulcanizing machine includes a second clamping part provided on one of the first plate and the second plate that is moved by the mold-moving mechanism, wherein the second clamping part is engaged with the second clamping groove so as to fix a relative position between the first plate and the second plate together with the clamping mechanism, it is possible to maintain the molds in the clamped state by fixing the positions of the first plate and the second plate by causing the second clamping groove in the guide rod and the second clamping part to be engaged with each other and to be locked. That is, because the clamping mechanism is provided not only on the clamping rod but also on the guide rod, it is possible to further increase the force for holding the molds in the clamped state.

In addition, in the guide rod and the clamping rod, when the cross-sectional area of the guide rod in the widthwise direction and the cross-sectional area of the clamping rod in the widthwise direction are adjusted such that the pressure generated inside the clamped first and second molds is evenly applied to the guide rod and the clamping rod when the relative position between the first plate and the second plate is fixed so as to maintain the clamped state of the first mold and the second mold, the magnitude and direction of the force for stretching the molds due to the pressure generated inside the molds are evenly distributed, and thus it is becomes easy to maintain the levelness of the clamped molds. As a result, it is possible to further suppress the phenomenon in which the first mold and the second mold, when clamped, tend to open due to the pressure generated when the tire is heated and pressed.

In order to achieve the object described above, a tire-vulcanizing method includes: a mold-clamping step in which a first plate, on which a first mold provided with a bladder configured to heat and press a green tire is mounted, and a second plate, on which a second mold configured to cooperate with the first mold so as to be capable of sandwiching the bladder therebetween is mounted, are moved relative to each other along a guide rod mounted on the first plate and the second plate so as to clamp the first mold and the second mold; and a clamping step in which a clamping groove provided at a tip end side of a clamping rod provided on either one of the first plate and the second plate and protruding towards the remaining plate is engaged with a clamping part provided on the remaining plate so as to fix the relative position between the first plate and the second plate and to maintain the clamped state of the first mold and the second mold. The mold-clamping step includes a guide step for guiding movement of the tip end side of the clamping rod after the green tire mounted on the bladder and the surface of the second mold facing the green tire are located close to each other and until the first mold and the second mold are clamped.

Here, by guiding the movement of the tip end side of the clamping rod after the green tire mounted on the bladder and the surface of the second mold facing the green tire are located close to each other and until the first mold and the second mold are clamped, it is possible to prevent misalignment of the center position of the green tire relative to the center position of the second mold from easily occurring when clamping the molds. That is, when the first mold and the second mold are clamped, the guide mechanism guides the movement of the tip end side of the clamping rod. Thus, the movement of the clamping rod, the first mold, or the second mold is stabilized. Along therewith, for example, even if the second mold mounted on the second plate is in a cantilevered state when viewed from the guide rod, it is possible to suppress misalignment of the center position of the second mold due to bending or the like when guiding by the guide mechanism is started.

### Advantageous Effects

The tire-vulcanizing machine according to the present disclosure has a simple mechanism, is capable of handling various mold heights, is capable of attaining device miniaturization, and is excellent in handleability.

In addition, the tire-vulcanizing method according to the present disclosure is a method of performing tire vulcanization using a tire-vulcanizing machine, which is a simple mechanism, is capable of handling various mold heights and attaining device miniaturization, and is excellent in handleability.

### BRIEF DESCRIPTION OF THE DRAWINGS

FIG. 1A is a schematic plan view illustrating the structure of a conventional tire-vulcanizing machine, and FIG. 1B is a schematic front view illustrating the state in which the molds of the tire-vulcanizing machine illustrated in FIG. 1A are opened;

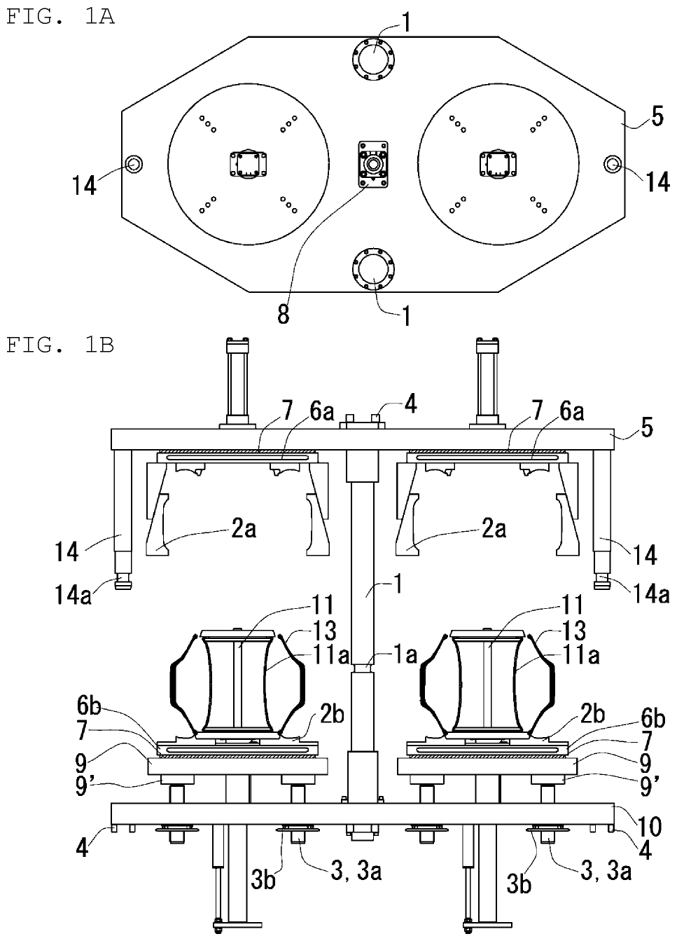

FIG. 2 is a schematic front view illustrating the state in which the molds of the tire-vulcanizing machine illustrated in FIG. 1A are fully closed;

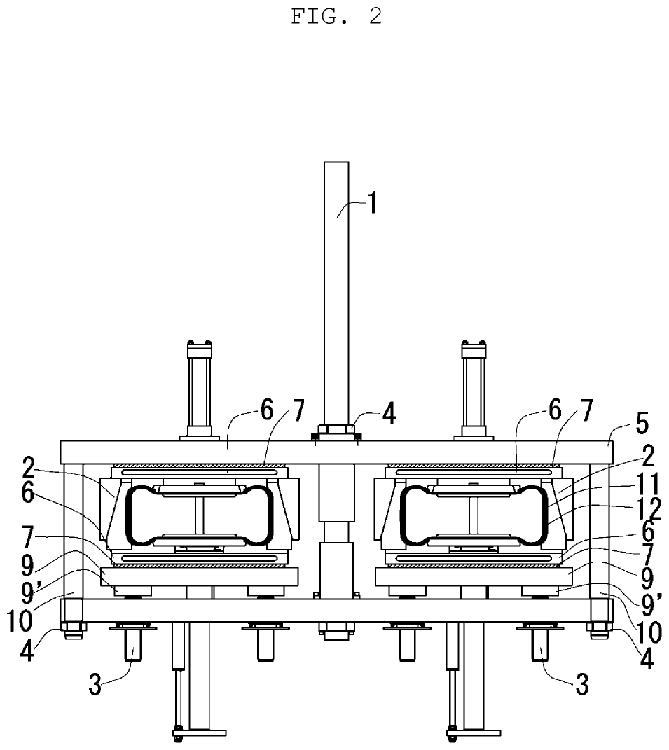

FIG. 3A is a schematic plan view illustrating the structure of an embodiment of the tire-vulcanizing machine to which the present disclosure is applied, and FIG. 3B is a schematic front view illustrating the state in which the molds of the tire-vulcanizing machine illustrated in FIG. 3A are opened;

FIG. 4 is a schematic front view illustrating the state in which the molds of the tire-vulcanizing machine illustrated in FIG. 3A are fully closed;

FIG. 5A is a view illustrating the state before clamping rods are engaged with the guide bushes, FIG. 5B is a view illustrating the state in which the clamping rods start to be engaged with the guide bushes, and FIG. 5C is a view illustrating the state in which the clamping grooves in the clamping rods are engaged with the clamping devices and the molds are fully closed; and

FIG. 6A is a schematic front view illustrating a tire-vulcanizing machine in which the pressing mechanism has a donut-shaped cylinder, and FIG. 6B is a schematic front view illustrating a tire-vulcanizing machine in which the pressing mechanism has a hydraulic cylinder.

### MODE FOR CARRYING OUT THE INVENTION

Hereinafter, modes for carrying out the disclosure (hereinafter, referred to as “embodiments”) will be described with reference to the accompanying drawings.

In all the drawings for explaining embodiments, members having the same function are denoted by the same or related reference numerals, and repeated descriptions thereof will be omitted. This point is the same not only in the drawings illustrating the structures of the embodiments of the present disclosure, but also in the drawings illustrating the device structure of the prior art.

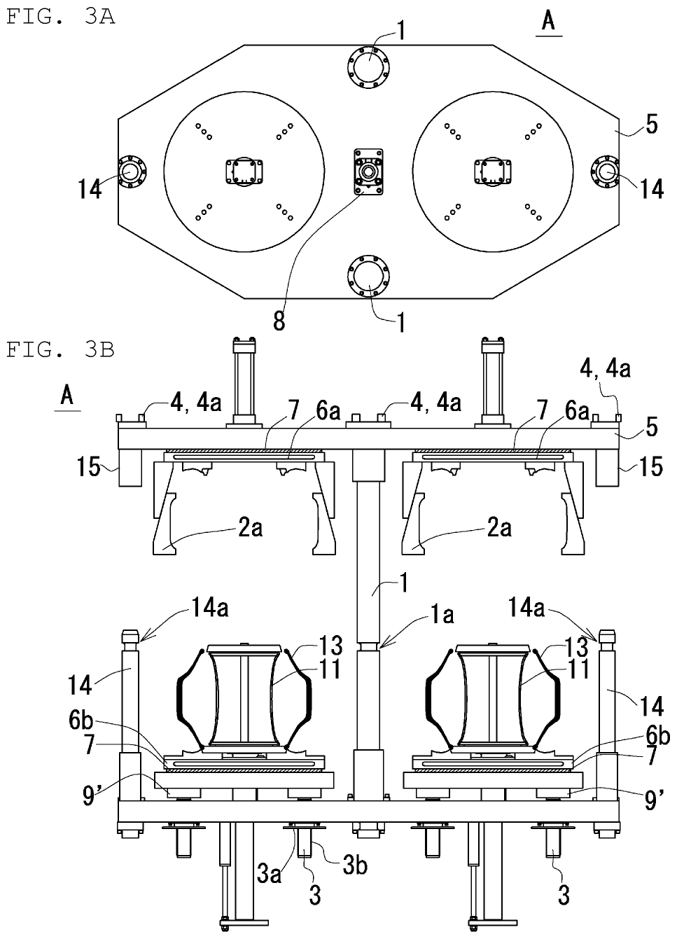

Hereinafter, with reference to FIG. 3B, a direction substantially parallel to the longitudinal direction of the guide rods 1 will be referred to as an “up-and-down direction” or a “vertical direction”. In addition, with reference to FIG. 3B, the position of the base 10 with respect to the bolster 5 will be referred to as “downward (vertically downward)” or “lower side” in the up-and-down direction (vertical direction), and the position of the bolster 5 with respect to the base 10 will be referred to as “upward (vertically upward)” or “upper side” in the up-and-down direction (vertical direction).

In the following, the direction substantially orthogonal to the up-and-down direction (vertical direction) will be referred to as the left-and-right direction with reference to FIG. 3B. Further, in the left-and-right direction with reference to FIG. 3B, the positions of the guide rods 1 with respect to the two clamping rods 14 will be referred to as “inner” or “inside”, and the positions of the two clamping rods 14 with respect to the guide rods 1 will be referred to as “outer” or “outside”.

### Embodiment

An embodiment of the present disclosure will be described with reference to FIGS. 3 to 5.

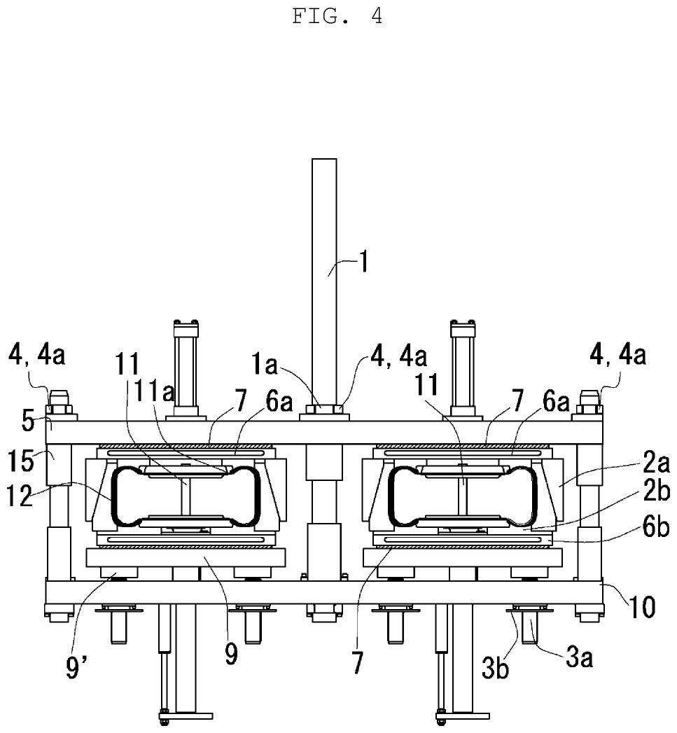

FIG. 3A is a schematic plan view illustrating the structure of an embodiment of a tire-vulcanizing machine to which the present disclosure is applied, and FIG. 3B is a schematic front view illustrating the state in which the molds of the tire-vulcanizing machine illustrated in FIG. 3A are opened. FIG. 4 is a schematic front view illustrating the state in which the molds of the tire-vulcanizing machine illustrated in FIG. 3A are fully closed. The structure illustrated below is an example of the present disclosure, and the contents of the present disclosure are not limited thereto.

As illustrated in FIGS. 3A and 3B, a tire-vulcanizing machine A, which is an embodiment of a tire-vulcanizing machine to which the present disclosure is applied, includes two guide rods 1, molds 2 each including an upper mold 2a and a lower mold 2b, a bolster 5, a base 10, and a mold-elevating device 8.

The upper mold 2a referred to here corresponds to the second mold according to the claims of the present application, and the lower mold 2b corresponds to the first mold according to the claims of the present application. The bolster 5 referred to here corresponds to the second plate in the claims of the present application, and the base 10 corresponds to the first plate in the claims of the present application. The mold-elevating device 8 referred to here corresponds to the mold-moving mechanism in the claims of the present application.

The tire-vulcanizing machine A is a twin-type tire-vulcanizing machine having two molds 2, each of which includes an upper mold 2a and a lower mold 2b. The tire-vulcanizing machine A is configured as a tire-vulcanizing machine in which the two molds move up and down at the same time.

In addition, the tire-vulcanizing machine A includes two clamping rods 14 and guide bushes 15 provided on the bolster 5. The guide bushes 15 and the clamping rods 14 referred to here correspond to the guide mechanism in the claims of the present application.

The guide rods 1 are substantially columnar rod-like bodies that connect the bolster 5 and the base 10 to each other, and are members that guide the movement of raising and lowering the bolster 5 via the mold-elevating device 8. In the tire-vulcanizing machine A, the bolster 5 is configured to be raised and lowered via the mold-elevating device 8. The mold-elevating device 8 includes a hydraulic cylinder.

The bolster 5 is a plate-shaped member on which each upper mold 2a is mounted via a heat-insulating plate 7 and an upper hot plate 6a. As described above, the bolster 5 can be raised and lowered via the mold-elevating device 8, and the distance thereof from the base 10 can be changed. That is, the bolster 5 and the upper molds 2a are raised and lowered in an integrated state, and are responsible for clamping and opening the upper molds 2a and the lower molds 2b.

The bolster 5 has three clamping devices 4 (see FIGS. 3B and 4). The clamping devices 4 are members each including a clamping block 4a and engaged with a clamping groove 1a or a clamping groove 14a, which will be described later, so as to fix the bolster 5.

That is, the clamping blocks 4a constitute, together with the clamping groove 1a or the clamping groove 14a, a clamping mechanism that fixes the bolster 5 at the tire vulcanization position and maintains the pressing force of the molds 2.

Since the structure for fixing the bolster 5 by fitting the clamping blocks 4a into the clamping grooves 1a or the clamping grooves 14a may adopt a known structure provided in a conventional tire-vulcanizing machine (see, for example, Patent Document 1), a detailed description thereof will be omitted.

Among the three clamping devices 4, two left and right clamping devices 4 provided near the guide bushes 15 correspond to the first clamping part in the claims of the present application. The central clamping device 4 corresponds to the second clamping part in the claims of the present application. The clamping blocks 4a and the clamping grooves 1a or the clamping grooves 14a referred to here correspond to the clamp mechanism in the claims of the present application.

The base 10 is a plate-shaped member on which the lower molds 2b are mounted via the screws 3b constituting a mold-height-adjusting mechanisms 3, the mold-pressing mechanisms 9′, the heat-insulating plates 7, and the lower hot plates 6b. The base 10 is a member that is paired with the bolster 5 so as to clamp the molds 2 therebetween. Further, the base 10 is a member that clamps the molds 2 in order to hold the pressing force of the clamped molds 2 in cooperation with the bolster 5.

The clamping rods 14 are substantially columnar rod-like bodies, the lower ends of which are fixed to the base 10. The clamping grooves 14a provided in the outer peripheral surfaces at the upper end sides thereof are engaged with the clamping blocks 4a provided on the bolster 5 so as to fix the bolster 5.

The guide bushes 15 are provided in the bolster 5 at positions facing the upper ends of the clamping rods 14 and positions corresponding to the clamping blocks 4a. The guide bushes 15 are tubular members each having a through hole through which a corresponding one of the clamping rods 14 is insertable.

The diameter of the through holes in the guide bushes 15 is slightly larger than the outer peripheral diameter of the upper end sides of the clamping rods 14. Thus, the guide bushes 15 serve as members for guiding the movement of the upper end sides of the clamping rods 14 towards the clamping blocks 4a via the mold-elevating device 8.

The clamping rods 14 have a length that is determined such that, at a position at which the surfaces of the upper molds 2a facing the upper portions of the green tires 13 are located close to the upper portions of the green tires 13, the upper ends of the clamping rods 14 reach the lower ends of the guide bushes 15 and start to be inserted into respective through holes in the guide bushes 15. The clamping rods 14 and the guide bushes 15 referred to here correspond to the guide mechanism in the claims of the present application.

As a result, when the bolster 5 is lowered via the mold-elevating device 8 and the upper molds 2a and the lower molds 2b are clamped with the green tires 13 vertically sandwiched therebetween, the movement of the end sides of the clamping rods 14 is guided in the flow until the clamping grooves 14a in the clamping rods 14 and the clamping blocks 4a are engaged with each other. This makes it possible to prevent misalignment of the center positions of the upper molds 2a and the center positions of the green tires 13 from easily occurring.

The cross-sectional areas of the guide rods 1 in the widthwise direction and the cross-sectional areas of the clamping rods 14 in the widthwise direction are adjusted so as to be substantially the same size. As a result, the pressure generated inside the molds 2 during tire vulcanization can be applied to the upper molds 2a and the lower molds 2b, and the direction of the pressure and the magnitude of the force applied to the upper and lower molds can be evenly distributed.

In the tire-vulcanizing machine A, the clamping grooves 1a are formed in the movement path of the bolster 5 on the outer peripheral surfaces of the guide rods 1. The clamping grooves 1a are portions into which the central clamping block 4a described above is engaged so as to fix the position of the bolster 5 in the up-and-down direction.

The clamping grooves 1a are disposed at a position matching the clamping position for fixing the bolster 5 when the bolster 5 is clamped by the clamping grooves 14a provided in the clamping rods 14. That is, the tire-vulcanizing machine A has a clamping position at which the tire-vulcanizing machine A is clamped by the clamping grooves 1a and the clamping grooves 14a.

The tire-vulcanizing machine A has mold-height-adjusting mechanisms 3. The mold-height-adjusting mechanisms 3 are mechanisms for changing the height position of the lower molds 2b with respect to the base 10 in the up-and-down direction. Each mold-height-adjusting mechanism 3 includes a nut 3a and a screw 3b.

Since the mold-height-adjusting mechanism 3 of the tire-vulcanizing machine A may adopt a known structure provided in a conventional tire-vulcanizing machine, a detailed description thereof will be omitted.

The tire-vulcanizing machine A has mold-pressing mechanisms 9′. The mold-pressing mechanisms 9′ are members that apply pressure to the clamped molds 2 from the outside so as to hold the pressing force of the molds 2.

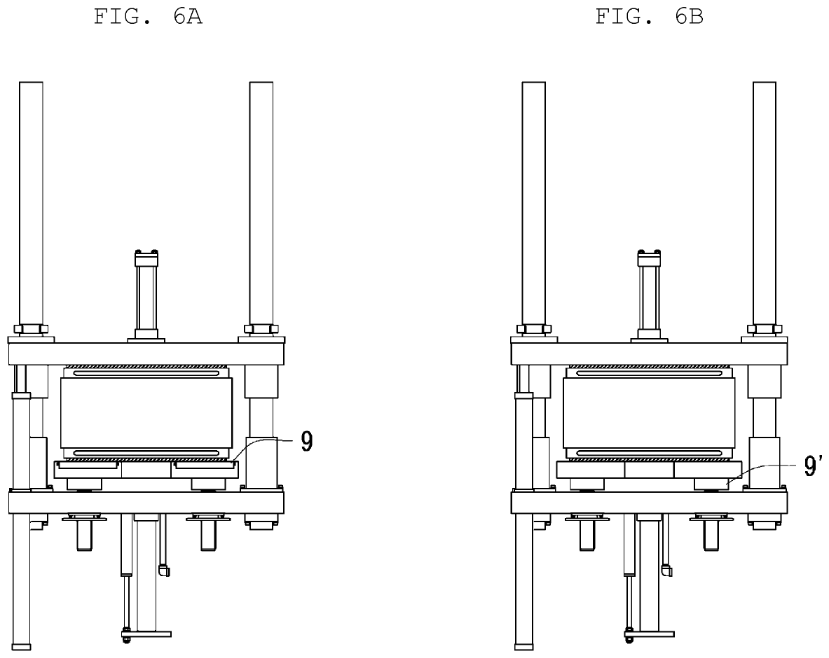

Each mold-pressing mechanism 9′ includes a hydraulic cylinder mounted on one of the lower molds 2a via a screw 3b. Since the mold-pressing mechanism using the hydraulic cylinder may adopt a known structure provided in a conventional tire-vulcanizing machine, a detailed description thereof will be omitted (see FIG. 6B).

As a mold-pressing mechanism, the present disclosure may adopt a donut-type mold-pressing mechanism 9 (see FIG. 6A), in which the cylinder piston has a hollow donut shape, has an area equal to or greater than the area between the inner and outer diameter of the maximum outer diameter tire, and is pressed with a compressed gas such as nitrogen or air.

The present disclosure may also adopt a structure in which the mold-pressing mechanisms are provided on the upper portions of the molds. Further, as the mold-pressing mechanism, a system in which a hydraulic cylinder is disposed at the lower end of each guide rod, and, after clamping, the guide rods are pulled down so as to apply pressing force to the molds, may also be adopted.

Here, the bolster 5 does not necessarily have to be configured to be able to be moved up and down by the mold-elevating device 8, and it is sufficient if the molds 2 can be clamped and the clamped molds 2 can be clamped by the upper and lower plates. That is, it is not necessarily limited to a mechanism in which the bolster 5 moves up and down with respect to the fixed base 10. For example, a structure in which the bolster 5 is fixed and the base 10 is raised and lowered via the mold-elevating device may be adopted.

Further, the guide rods 1 do not necessarily have to be adopted as the members for guiding the raising and lowering of the bolster 5, and a member other than the guide rods 1 may be used, as long as the member has a structure capable of guiding the raising and lowering of the bolster 5. For example, in a structure in which the upper plate is guided via a guide rail or a guide groove found in a conventional plate-type tire-vulcanizing machine, a structure in which a clamping groove is formed in the guide rail or the guide groove may also be adopted.

The mold-elevating device 8 does not necessarily have to include a hydraulic cylinder, and other mechanisms may be adopted, as long as the bolster 5 can be raised and lowered. For example, the bolster 5 may be configured to be raised and lowered by a motor-driven screw system in which a motor and a screw structure are combined.

The lower ends of the clamping rods 14 do not necessarily have to be fixed to the base 10 so as to be engaged with the clamping blocks 4a provided on the bolster 5. For example, the upper ends of the clamping rods may be fixed to the bolster 5, the clamping grooves 14a may be provided at the lower end sides of the clamping rods, and the clamping device 4 (clamping block 4a) may be provided on the base 10.

The clamping grooves do not necessarily have to be provided in all of the clamping rods 14 and the guide rods 1. For example, a structure in which the clamping grooves are provided only in the clamping rods 14 can be adopted.

The guide mechanism does not necessarily have to be configured by the clamping rods 14 and the guide bushes 15. For example, it is possible to configure the guide mechanism using only the guide bushes 15. In this case, the clamping rods may be made shorter than the clamping rods 14 and the guide bushes 15 may be made longer such that, at a position at which the surfaces of the upper molds 2a facing the upper portions of the green tires 13 are located close to the upper portions of the green tires 13, the upper ends of the clamping rods reach the lower ends of the guide bushes.

For example, it is also possible to configure the guide mechanism by increasing the length of the clamping rods 14 without providing the guide bushes 15. In this case, the upper ends of the clamping rods may be made to reach the lower ends of the clamping blocks 4a at a position at which the surfaces of the upper molds 2a facing the upper portions of the green tires 13 are located close to the upper portions of the green tires 13. As described above, it is sufficient if the guide mechanism in the claims of the present application has a structure in which, when the surfaces of the upper molds 2a facing the upper portions of the green tires 13 are located close to the upper portions of the green tires 13, the movement of the tip ends of the clamping rods is guided. More specifically, it is sufficient if the guiding of the clamping rods 14 is started before the green tires 13 come into contact with the molds 2.

The cross-sectional areas of the guide rods 1 in the widthwise direction and the cross-sectional areas of the clamping rods 14 in the widthwise direction do not necessarily have to be adjusted to be substantially the same size. However, in view of the fact that the pressure generated inside the molds 2 during tire vulcanization is applied to the upper molds 2a and the lower molds 2b and that the levelness of the molds 2 is maintained by evenly distributing the direction of the pressure and the magnitude of the force that is applied to the upper and lower molds, it is preferable to adjust the cross-sectional area of each rod in accordance with the disposed position of each rod.

As illustrated in FIGS. 3B and 4, an upper mold 2a and a lower mold 2b are a pair of members constituting a mold 2. The upper mold 2a and the lower mold 2b are clamped, and a green tire 13 disposed therein is heated and pressed.

More specifically, a bladder 11a is arranged between the upper mold 2a and the lower mold 2b. The bladder 11a is a member that supports a green tire 13 and a vulcanized tire, and presses the green tire 13 against the mold 2 so as to mold the tire under a high-temperature and high-pressure condition.

In addition, the bladder 11a is configured to be expandable and contractible by supplying a vulcanization medium to the inside from a vulcanization medium supply source (not illustrated). During tire vulcanization, the green tire 13 held by the bladder 11a from the inner peripheral surface side thereof is covered with the upper mold 2a and the lower mold 2b.

In addition, the tire-vulcanizing machine A has a bladder-elevating device 11. The bladder-elevating device 11 is a device that raises and lowers the bladder 11a during the step of tire vulcanization to change the height position in the up-and-down direction. The bladder-elevating device 11 is configured to be able to control the movement thereof in cooperation with the movement of the mold-elevating device 8.

The contents of a series of operations for performing tire vulcanization using the tire-vulcanizing machine A according to an embodiment of the present disclosure described above will be described.

First, green tires 13 are held by a tire-loading device (not illustrated), and the tire-loading device is lowered in order to mount the green tires 13 on the outsides of the bladders 11a. In addition, the bolster 5 is lowered along the guide rods 1 by the mold-elevating device 8 so as to move the upper molds 2a and the lower molds 2b in the direction in which the molds are clamped.

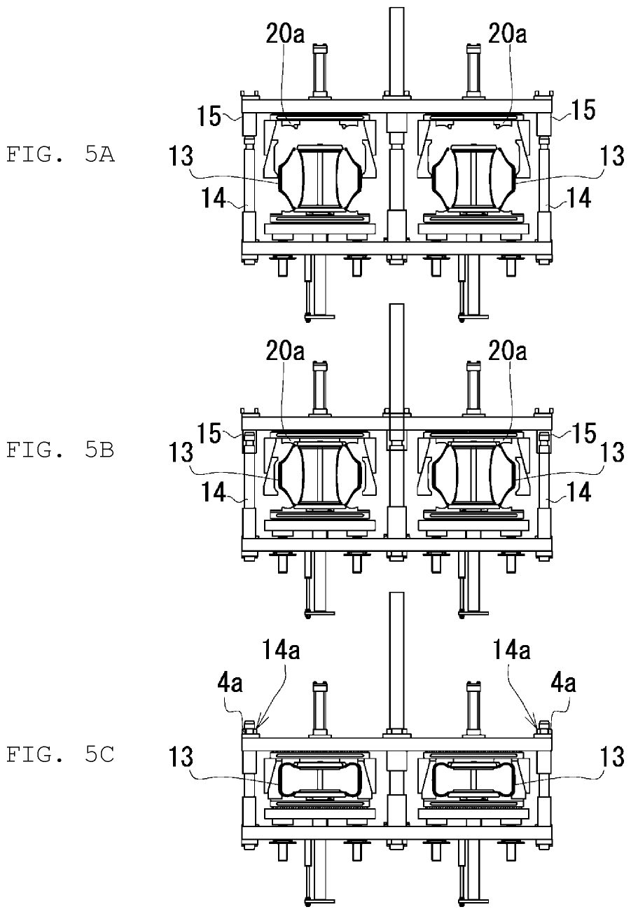

At this time, the distance between the upper end sides of the clamping rods 14 and the guide bushes 15 is shortened, and the upper ends of the clamping rods 14 move until just before being engaged with the through holes in the guide bushes 15 (see FIG. 5A).

In addition, as illustrated in FIG. 5B, when the surfaces 20a of the upper molds 2a facing the upper portions of the green tires 13 are located close to the upper portions of the green tires 13, the movement of the upper end sides of the clamping rods 14 is guided by the guide bushes 15.

When the bolster 5 is lowered, the upper ends of the clamping rods 14 are guided upwards, the upper molds 2a and the lower molds 2b are engaged with each other, and the molds 2 are closed (clamping of the molds 2). The molds 2 are then fully closed (see FIG. 5C).

Further, by lowering the bolster 5, the left and right clamping blocks 4a of the bolster 5 are engaged with the clamping grooves 14a in the clamping rods 14. At the same time, the clamping block 4a in the center of the bolster 5 is engaged with the clamping grooves 1a in the guide rods 1.

That is, after the upper molds 2a and the lower molds 2b are engaged with each other so as to be clamped, the clamping blocks 4a of the bolster 5 are engaged with the clamping grooves 1a and the clamping grooves 14a, and the molds 2 are clamped by the bolster 5 and the base 10.

In addition, a vulcanization heat medium such as steam is supplied to the inside of the bladders 11a to expand the bladders along the inside of the green tires 13. In addition, the bladders 11a are lowered to the fully closed position of the molds 2 via the bladder-elevating devices 11 in synchronization with the lowering movement of the upper molds 2a.

After the molds 2 are clamped, the molds 2 are pressed by the pressing devices 9′. In addition, the green tires 13 are heated from the outside through the upper hot plates 6a and the lower hot plates 6b from the outer peripheral sides of the molds 2. Further, a vulcanization heat medium such as steam is supplied to the insides of the bladders 11a, and the green tires 13 are pushed and pressed against the inner surfaces of the molds 2 while being heated from the insides thereof, thereby starting tire vulcanization.

After tire vulcanization is completed, the pressure of the pressing devices 9′ is lowered to release the pressing devices from the state in which the pressing is maintained, and the engagement between the clamping blocks 4a and the clamping grooves 1a and the clamping grooves 14a is released. In addition, the tires after vulcanization are released from the state in which the upper molds 2a are raised and fastened.

In addition, the bladders 11a are removed from the tires by the bladder-elevating devices 11, the tires are taken out of the tire-vulcanizing machine A by a tire extraction device (not illustrated), and the tires are moved to the next step. The vulcanization of green tires in the tire-vulcanizing machine A is completed through the flow described above.

In the tire-vulcanizing machine A described above, even if the upper molds 2a are cantilevered by the guide rods 1 when the molds 2 are clamped, the movement of the tip ends of the clamping rods 14 can be guided through the guide mechanism based on the lengths of the guide bushes 15 and the clamping rods 14. As a result, the movement of the clamping rods 14 and the upper molds 2a is stable during the clamping of molds, and thus it is possible to suppress the occurrence of misalignment between the center positions of the green tires 13 and the center positions of the molds 2 due to bending or the like.

As described above, the tire-vulcanizing machine according to the present disclosure is capable of positioning green tires and molds with high accuracy in the step of clamping the molds and attaining device miniaturization, and is excellent in handleability.

In addition, the tire-vulcanizing method according to the present disclosure is a method of performing tire vulcanization using a tire-vulcanizing machine, which is capable of positioning green tires and molds with high accuracy in the step of clamping the molds and attaining device miniaturization, and is excellent in handleability.

### DESCRIPTIONS OF REFERENCE NUMERALS

1: guide rod
1a: clamping groove
2: mold
2a: upper mold
2b: lower mold
3: mold-height-adjusting mechanism
3a: nut
3b: screw
4: clamping device
4a: clamping block
5: bolster
6a: upper hot plate
6b: lower hot mold
7: heat-insulating plate
8: mold-elevating device
9: mold-pressing mechanism (donut type)
9′: mold-pressing mechanism (hydraulic cylinder type)
10: base
11: bladder-elevating device
11a: bladder
12: tire
13: green tire
14: clamping rod
14a: clamping groove
15: guide bush

1. A tire-vulcanizing machine comprising:
a first plate, on which a first mold is mounted, including a bladder configured to heat and press a green tire;
a second plate, on which a second mold is mounted, configured to cooperate with the first mold to hold the bladder therebetween;
a substantially columnar guide rod mounted on the first plate and the second plate to guide movement of the first plate and the second plate relative to each other;
a mold-moving mechanism configured to move the first plate and the second plate relative to each other along the guide rod;
a clamping mechanism which includes a clamping; and
a guide mechanism configured to interact with the clamping rod,
wherein the clamping rod is a substantially columnar body provided on either one of the first plate and the second plate and protrudes towards a remaining plate,
wherein the clamping rod includes:
a first clamping groove formed at a protruding tip end side thereof; and
a first clamping part provided on the remaining plate at a position facing the tip end of the clamping rod,
wherein the first clamping part is engaged with the first clamping groove to fix the first plate and the second plate to positions relative to each other and to maintain a clamped state of the first mold and the second mold, and
wherein, when the first plate and the second plate are moved relative to each other by the mold-moving mechanism to clamp the molds, the guide mechanism is configured to guide movement of the tip end side of the clamping rod at a position at which the green tire that is mounted on the bladder is approximately located to a surface of the second mold facing the green tire,
wherein the guide mechanism includes:
a guide bush which includes a through hole that permits insertion of the tip end side of the clamping rod therethrough; and
the guide mechanism which is further configured to permit the tip end side of the clamping rod to reach the guide bush and to guide the movement of the tip end side of the clamping rod,
wherein the tip end side of the clamping rod, the first clamping groove, and the first clamping part are configured to engage with each other to fix a relative position between the first plate and the second plate to maintain force for pressing the first mold and the second mold during tire vulcanization,
wherein the tip end side of the clamping rod is directed by the guide bush to reach the first clamping part,
wherein the guide bush is a substantially tubular body provided on the remaining plate at a position of the first clamping part, and
wherein the guide bush is constructed to protrude towards the first plate.

2. The tire-vulcanizing machine of claim 1, wherein the guide rod is provided at an approximate center between the first plate and the second plate when viewed from a front side, and
wherein the guide rod is configured to support the first plate or the second plate when the first mold and the second mold are opened.

3. The tire-vulcanizing machine of claim 1, wherein the guide mechanism includes:
the guide rod having a length that causes the tip end of the clamping rod to be engaged with the first clamping part at a position where the green tire, which is mounted on the bladder, is approximately located to the surface of the second mold facing the green tire.

4. (canceled)

5. The tire-vulcanizing machine of claim 1, wherein a second clamping groove is formed at a predetermined position in a longitudinal direction of the guide rod,
wherein, a second clamping part is provided on one of the first plate and the second plate that is moved by the mold moving mechanism, and
wherein the second clamping part is engaged with the second clamping groove to fix a relative position between the first plate and the second plate together with the clamping mechanism.

6. The tire-vulcanizing machine of claim 5, wherein, when the relative position between the first plate and the second plate is fixed to maintain the clamped state of the first mold and the second mold, a cross-sectional area of the guide rod in a widthwise direction and a cross-sectional area of the clamping rod in a widthwise direction are adjusted such that pressure generated inside the clamped first and second molds is evenly applied to the guide rod and the clamping rod.

7. (canceled)
